(19) United States
(12) Patent Application Publication
(10) Pub. No.: US 2003/0162085 A1
(43) Pub. Date: Aug. 28, 2003

(54) Separator configuration providing a reservoir and wicking system for electrolyte

(76) Inventors: Cynthia Carol Sauseda, Bryan, TX (US); Boris G. Shpeizer, Bryan, TX (US)

Correspondence Address: FACTOR & PARTNERS, LLC, 1327 W. WASHINGTON BLVD., SUITE 5G/H, CHICAGO, IL, 60607, US

(21) Appl. No.: 10/083,006

(22) Filed: Feb. 25, 2002

(51) Int. Cl. H01M 2/38

(52) U.S. Cl. 429/80; 429/81

(57) ABSTRACT

The present invention is directed to a system for transportation of electrolyte for use in an electrochemical cell. The system comprises a reservoir space located within the cell and below at least two electrodes of the cell, and at least one layer of absorptive material situated between the at least two electrodes, one or more layers of absorptive material being longer in length so as to protrude into the reservoir space.

### BACKGROUND OF THE INVENTION

1. Field of the Invention

The present invention relates in general to electrochemical cells, and more particularly, to a method of incorporating a means for efficient electrolyte distribution and storage in rechargeable nickel-zinc cells.

2. Background Art

Rechargeable electrochemical cells have been known in the art for years, and include, for example, nickel/zinc, silver/zinc, zinc/air and manganese dioxide/zinc type electrochemical cells. This present invention pertains to rechargeable nickel-zinc cells. As batteries increase in importance during the foreseeable future, nickel-zinc cells become more attractive because of their low cost and high rate capabilities. Nickel-zinc cells must also have viable cycle life so as to compete with alternative battery systems. This invention is directed to a method for improving cell performance by incorporating a system for transportation of electrolyte, including a reservoir and absorptive material, into the stack assembly of a nickel-zinc cell.

In order for a battery to function properly, it is necessary to have good electrolyte management. Good electrolyte management includes providing an adequate supply of electrolyte as well as the means to distribute the electrolyte throughout the electrode stack where and when it is needed. There are several factors involved in electrolyte management. For example, internal pressure initially increases within the electrode stack, due to the expansion of materials from absorption of electrolyte. Another factor is the electrochemical conversion of physically smaller elements or compounds into larger elements or compounds, and vice versa, with each charge and discharge cycle. When the cell stack expands, it is believed that the increased pressure squeezes the electrolyte out of the electrode stack and into any free volume available in the cell case. In many rechargeable cells, the only free volume available is the headspace at the top of the case near the vent and terminals. This results in free electrolyte gathering above the electrodes.

Gas is produced during charge and discharge cycles. When the pressure from the gas becomes great enough, it is released through a vent at the top of the battery case, above the headspace. As a result of the proximity of the free electrolyte and the location of the vent, a substantial amount of electrolyte can escape when internal pressure is too high. It has been observed that in some cases, as much as a quarter of the electrolyte can be lost during the first ten to twenty cycles.

Another drawback to free electrolyte collecting above the electrodes is that it blocks the gases from recombining on the anode. Free electrolyte also eliminates the use of any recombination catalyst since it can not function properly when immersed in electrolyte.

The reservoir and wicking system of the present invention solves the problems detailed above by providing a reservoir for the electrolyte which can be accessed and transported throughout the electrode stack when needed. It also works in the reverse manner. When the internal pressure builds within the stack, the electrolyte has a place to go instead of collecting above the electrodes. Such reduces the problem of electrolyte losses through the vent and creates an environment more conducive to gas recombination. Retention of electrolyte and quicker redistribution throughout the cell via the wicking system lends to longer cycle life, increased capacity utilization, and increased rate capacity.

As will become apparent, it is an object of the present invention to promote longer cycle-life, better capacity utilization, and increased rate capability in rechargeable zinc alkaline batteries through the design and implementation of a separator configuration that creates an internal reservoir and wicking system.

It is yet another object of the present invention to improve electrolyte containment to the point that all electrolyte is absorbed by the internal components, and to improve redistribution of electrolyte between charge and discharge cycles.

These and other objects of the invention will become apparent in light of the present specification, claims, and drawings.

### SUMMARY OF THE INVENTION

The present invention is directed to a system for transportation of electrolyte for use in an electrochemical cell comprising a reservoir space located within the cell and below the electrodes of the cell. At least one layer of absorptive material is situated between the electrodes. The absorptive material is longer in length than the electrodes so as to protrude into the reservoir space.

In a preferred embodiment of the present invention, one or more layers of absorptive material are situated between various electrodes of the cell. Alternatively, absorptive material is situated between each electrode of the cell.

In another preferred embodiment of the present invention, one or more layers of absorptive material defines a path along which electrolyte can travel from the reservoir space to the electrodes, and from the electrodes to the reservoir space.

In another preferred embodiment of the present invention, the at least one layer of absorptive material has a portion which protrudes into the reservoir space. The protruding portion is folded in an “accordion” fashion, rolled up, or having any other geometric configuration so as to increase the surface area of that portion of the absorptive material protruding into the reservoir space.

In yet another preferred embodiment of the present invention, the reservoir space further comprises a support structure. In this embodiment, the support structure is rolled up, folded, or otherwise geometrically configured so as to sustain the at least one layer of absorptive material. It is contemplated that the support structure provides additional free volume of electrolyte in the reservoir space.

The present invention is also directed to a system for transportation of electrolyte for use in an electrochemical cell comprising a reservoir space located within the cell and below the electrodes of the cell. At least one layer of absorptive material is situated between the electrodes. The absorptive material is longer in length than the electrodes so as to protrude into the reservoir space, where the reservoir space farther comprises a support structure.

The present invention is further directed to an electrochemical cell, comprising: at least one cathodic electrode, an alkaline electrolyte, at least one anodic electrode, and a system for transportation of electrolyte comprising a reservoir space located within the cell and below the electrodes. At least one layer of absorptive material is situated between the electrodes. The absorptive material is longer in length than the electrodes so as to protrude into the reservoir space.

In a preferred embodiment of the present invention, the electrochemical cell comprises a plurality of cathodic electrodes and anodic electrodes arranged in a stack configuration. In one embodiment, one or more layers of absorptive material are situated between various ones of the plurality of electrodes in the stack. In another embodiment, one or more layers of absorptive material are situated between each of the plurality of electrodes in the stack.

In accordance with the present invention, a method for manufacturing an electrochemical cell is disclosed which comprises the steps of a) providing a cathodic electrode, b) providing an alkaline electrolyte, c) providing an anodic electrode, and d) associating with the electrodes a system for transportation of electrolyte comprising a reservoir space located within the cell and below the electrodes, and at least one layer of absorptive material situated between the electrodes. One or more layers of absorptive material are longer in length than the electrodes so as to protrude into the reservoir space. A casing is provided to house the electrodes, electrolyte, absorptive material and reservoir space.

Finally, in accordance with the present invention, methods are disclosed which optimize electrolyte use, improve the cycle life, and improve the discharge capacity of an electrochemical cell.

### BRIEF DESCRIPTION OF THE DRAWINGS

The invention will now be described with reference to the drawings wherein:

FIG. 1 of the drawings is a schematic representation of an electrochemical cell fabricated in accordance with the present invention;

FIG. 2 of the drawings is a two-dimensional plot showing the relationship between the cycle life and discharge capacity of an electrochemical cell with a standard assembly as compared to an electrochemical cell fabricated in accordance with the present invention;

FIG. 3 of the drawings is a two-dimensional plot showing the rate profile of an electrochemical cell with a standard assembly as compared to an electrochemical cell fabricated in accordance with the present invention; and

FIG. 4 of the drawings is a two-dimensional plot showing electrolyte loss of an electrochemical cell with a standard assembly as compared to an electrochemical cell fabricated in accordance with the present invention.

FIG. 5 of the drawings is a schematic representation of the support structure fabricated in accordance with the present invention, and assembly of said structure into cell.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

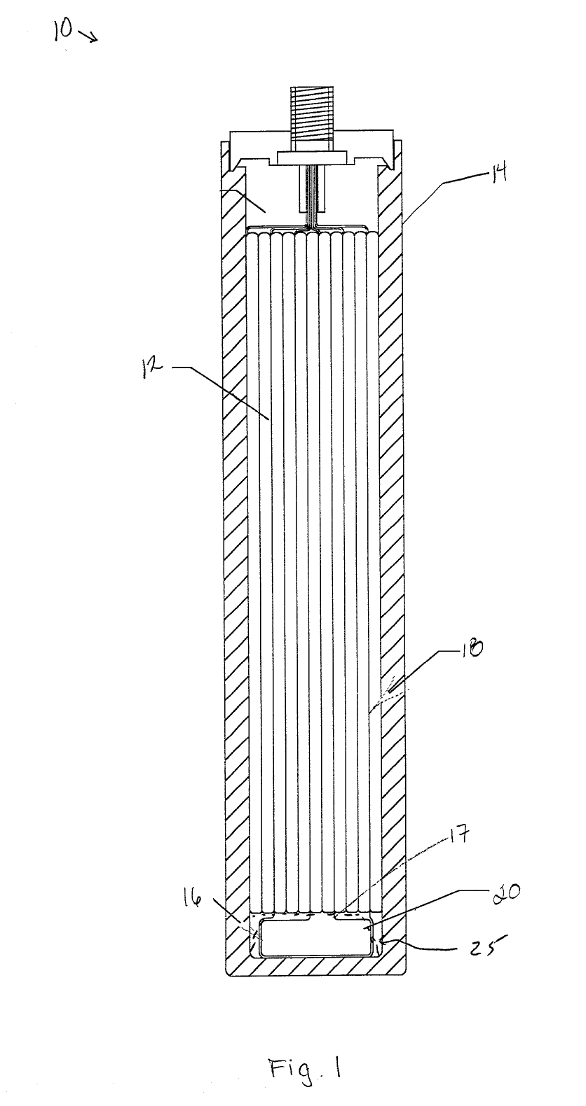

Referring now to the drawings, and to FIG. 1 in particular, a schematic representation of a first embodiment of electrochemical cell 10 is shown as generally comprising: a stack 12 of anodic electrodes and cathodic electrodes, an absorber 16 which is positioned between some of the electrodes, a path 18 defined by the length of the absorber 16, a reservoir space 20 located beneath the electrodes, and casing 14 which contains the aforementioned components of the electrochemical cell. It will be understood that FIG. 1 is merely a schematic representation of electrochemical cell 10. As such, some of the components may be distorted from their actual scale for pictorial clarity. Furthermore, it will be understood by one having ordinary skill in the art that the present invention is not limited to electrodes of a particular chemistry, nor is the present invention limited to the stack configuration of electrodes as depicted in FIG. 1.

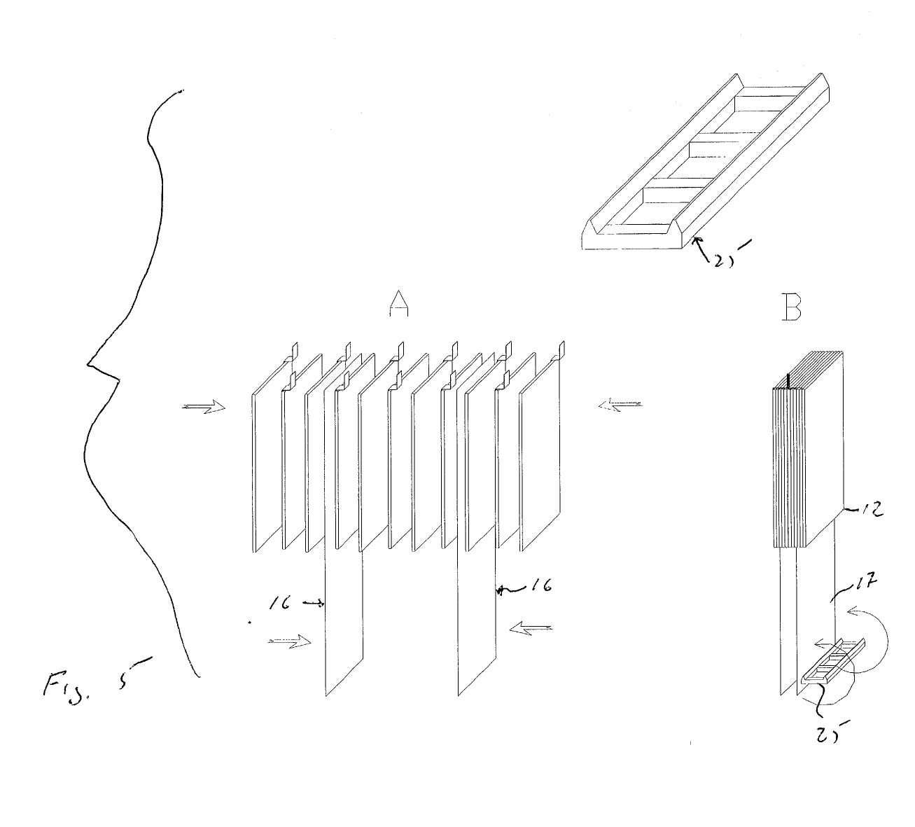

The system for transportation of electrolyte for use in electrochemical cell 10 is comprised of reservoir space 20 for the electrolyte as well as a “path” 18 for electrolyte to travel from reservoir space 20 into electrode stack 12, and for electrolyte to travel back to reservoir space 20 from electrode stack 12. The “path” 18 is created by assembling layers of an absorptive material 16 within the stack, between the electrodes. The absorber 16 may be placed between every electrode or only between a few electrodes. The layers of absorptive material 16 are sized to be longer than the electrodes (See, FIG. 5). This produces extra length of absorber 17 which protrudes from the bottom of the assembled electrode stack 12. The extra absorber 17 can then be oriented in reservoir space 20 so as to access all the electrolyte stored there. In sum, the extension of absorptive material 16 from the top of electrolyte stack 12 to the bottom of electrolyte stack 12 and into reservoir space 20 creates the “path” 18, or several paths between component anode electrodes and cathode electrodes of a stack, for electrolyte to travel from electrode stack 12 to reservoir space 20 when the internal stack pressure increases. It also allows electrolyte to be drawn from reservoir space 20 to the various electrodes of stack 12 during discharge when it is needed. It is also contemplated that this design offers increased protection caused by vibrations and impact by dampening the shock.

Reservoir space 20 is designed into the cell beneath the electrodes, or, as in the example shown in FIG. 1, beneath electrode stack 12. The space created for the reservoir may be full of extra absorber 17 protruding from stack 12 folded in an “accordion” fashion, rolled up, or oriented in a variety of ways. It is also contemplated that reservoir space 20 may further contain a support structure 25 (FIG. 5), (also, shown in dashed lines in FIG. 1) designed to be either rolled up or folded into protruding absorber 17. Such support structure acts to physically support the electrode stack while creating reservoir space 12, gives the electrodes a more solid foundation upon which to rest, and allows more electrolyte to be stored in reservoir space 12 since the support can provide some free volume. Support structure may be a non-absorptive or absorptive material, and can assume numerous variations in size and geometry. Furthermore, such a physical support structure allows for easier handling of the extra length of absorber.

In support of the present invention, the following experiment was conducted:

The reservoir and wicking system described herein was utilized in a 5 Ah nickel-zinc cell. The cell was assembled in a prismatic nylon case with a vent. A semitransparent, non-woven, thermally bonded fabric of crisscrossed fibers of 100% polyamide (nylon 6 and 6.6) from Freudenberg Nonwovens, 969 Washington St., Holliston, Mass. 01746 was used as the absorptive material in this particular instance. Four layers of absorber were interwoven between the electrode stack, which consisted of five nickel electrodes and six zinc anodes, as shown in FIG. 1. All electrodes were assembled with one layer of absorber, and the cathodes were assembled with layers of separator. A plastic physical support was inserted from the side into the U-shaped folds created by the absorber. This particular design allows pockets of free space in the support for electrolyte to occupy. The absorber is forced into the corners of the case since it is wrapped around the support. Therefore, any electrolyte in the reservoir should be accessible to the wicking system.

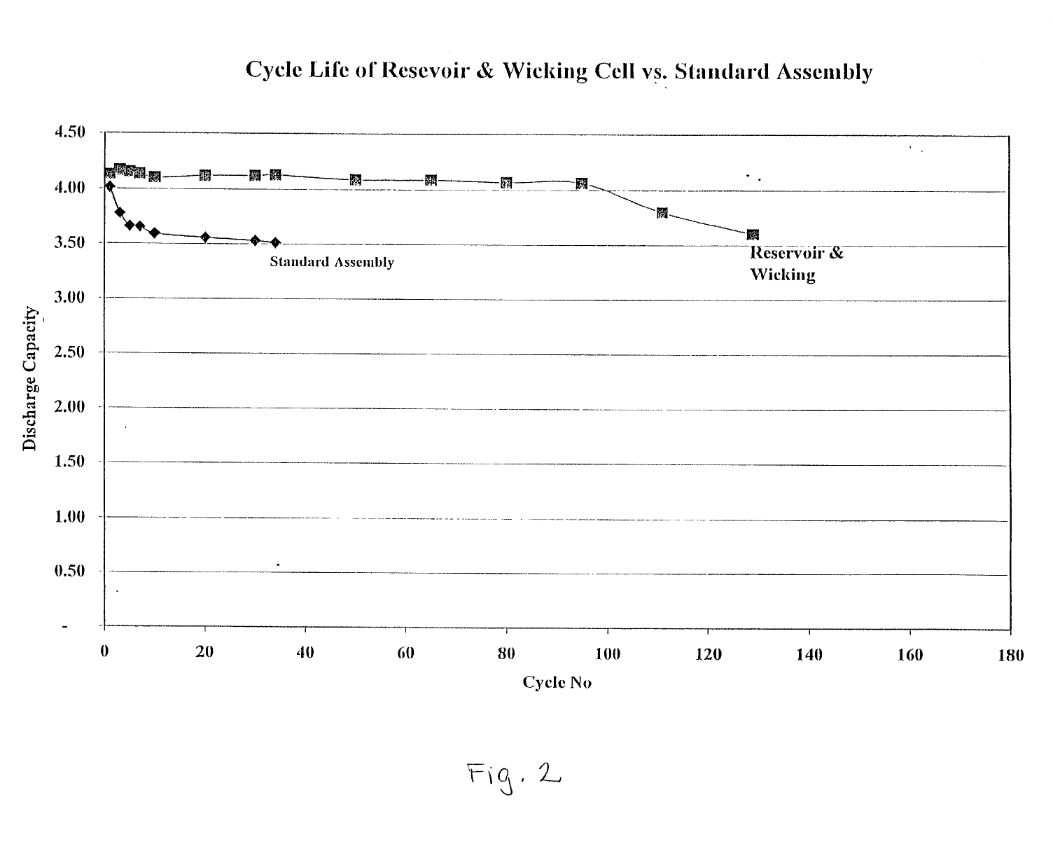

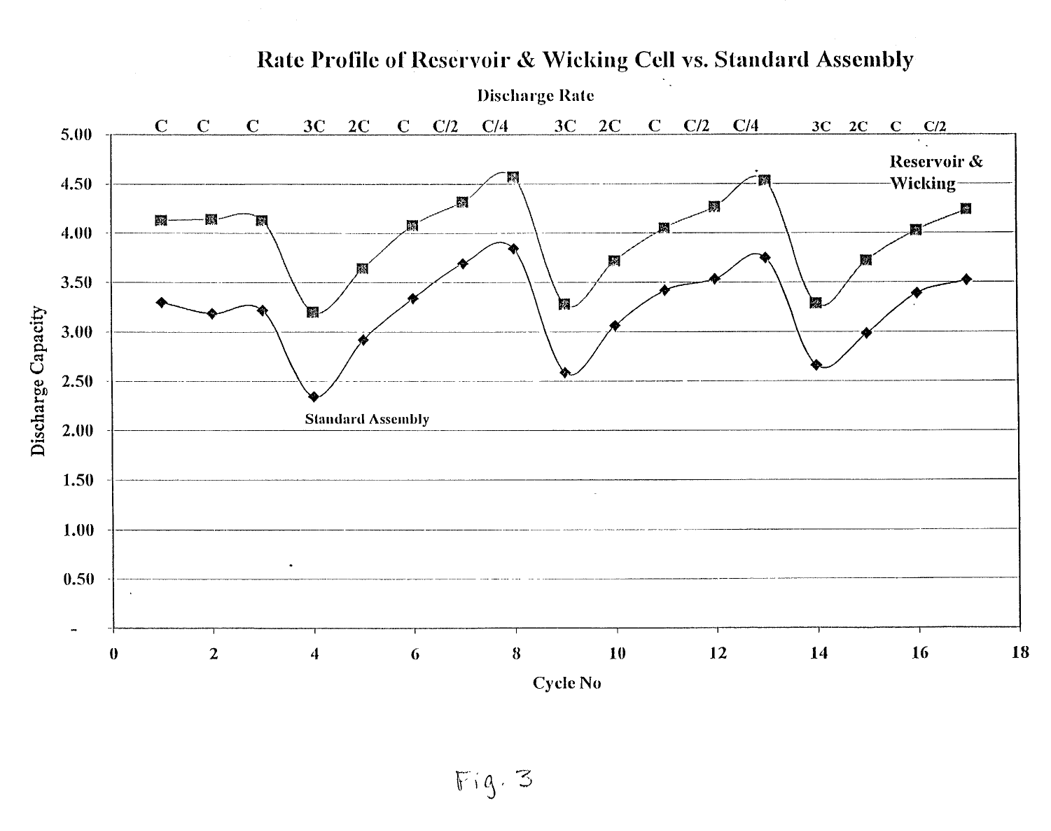

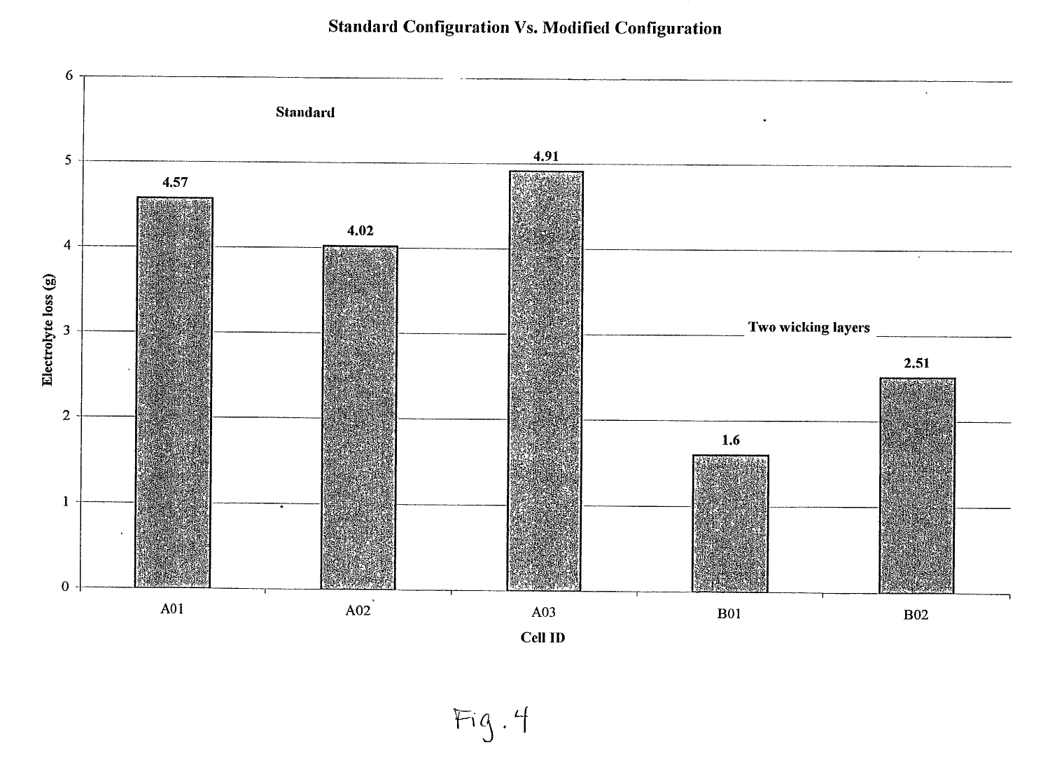

The cell, as assembled in accordance with the reservoir and wicking system, performed favorably as compared to a cell having standard assembly. It can be seen in FIG. 2 that the cell with the reservoir wicking system gave substantially longer cycle life, lower fade and increased capacity utilization when compared to the average performance of three cells that were identical in construction, except for the inclusion of the reservoir and wicking system. FIG. 3 displays the benefits that were observed in the reservoir and wicking cell during rate profile testing. It can be seen that the reservoir and wicking cell gave more than 0.5 Ah in capacity at all rates. FIG. 4 likewise depicts advantages over conventional devices.

Upon construction of a preferred embodiment of a cell which employs the use of a reservoir and wicking system as disclosed above, one can associate a reservoir with the electrodes by first positioning it directly beneath the electrodes. Next, at least one layer of absorptive material is positioned between the electrodes. The invention requires that the length of the layer or layers of absorptive material exceed the length of the electrodes, such that the “extra” absorptive material protrudes into the reservoir space. Those skilled in the art will appreciate that the actual length of the “extra” absorptive material that protrudes into the reservoir is not limited by the invention, and furthermore, may be folded, rolled up, or otherwise configured so as to both fit within the reservoir and increase the surface area of absorptive material available to receive electrolyte in the reservoir. Those skilled in the art will also appreciate that the invention does not limit the number of layers of absorptive material to be utilized. Noticeable, however, is a relationship between the number of absorptive layers utilized and the amount of electrolyte loss in the cell, as illustrated by FIG. 4. While FIG. 4 depicts the results of compared electrolyte loss between a standard cell without the reservoir and wicking system, and a cell modified to include the reservoir and wicking system having two absorptive layers, one skilled in the art can surmise that, depending on the absorptive material employed, and the application of the cell, additional layers of absorptive material may serve to further optimize electrolyte usage. Similarly, as the absorptive material can be of any hydrophilic material capable of transporting electrolyte to and from the electrodes, one is not limited by using any specific material. Furthermore, the invention does not provide that the layers of absorptive material be positioned between any number of electrodes; rather, positioning of the absorptive material can occur between any number of various electrodes, or between each electrode.

Following the fabrication of the electrodes, reservoir, and absorptive material, a casing is provided so as to house the components. Optionally, prior to housing all of the components within a casing, to help maintain the integrity of the “extra” absorptive material within the reservoir, one may position a support structure within the reservoir. The support structure may be rolled up, folded, or otherwise geometrically configured so as to sustain the layer or layers of “extra” absorptive material which protrude into the reservoir. Such a support structure has the effect of providing additional free volume of electrolyte in the reservoir space. Those skilled in the art will realize that the support structure may be comprised of either absorptive or non-absorptive material.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A system for transportation of electrolyte for use in a nickel zinc cell comprising:
reservoir space located within the cell and below electrodes of the cell; and
at least one layer of absorptive material situated between the electrodes, the at least one layer of absorptive material being longer in length so as to protrude into the reservoir space.

2. A system for transportation of electrolyte according to claim 1 wherein the at least one layer of absorptive material is situated between various electrodes of the cell.

3. A system for transportation of electrolyte according to claim 1 wherein the at least one layer of absorptive material is situated between each electrode of the cell.

4. A system for transportation of electrolyte according to claim 1 wherein the at least one layer of absorptive material defines a path along which electrolyte can travel from the reservoir space to the electrodes, and from the electrodes to the reservoir space.

5. A system for transportation of electrolyte according to claim 1 wherein a portion of the at least one layer of absorptive material protrudes from the bottom of the electrodes, the protruding length being folded in an “accordion” fashion, rolled up, or having any other geometric configuration so as to increase the surface area of absorptive material protruding into the reservoir space.

6. A system for transportation of electrolyte according to claim 1 wherein the reservoir space further comprises a support structure.

7. A system for transportation of electrolyte according to claim 6 wherein the support structure is rolled up, folded, or otherwise geometrically configured so as to sustain the at least one layer of absorptive material.

8. A system for transportation of electrolyte according to claim 7 wherein the support structure has the effect of providing additional free volume of electrolyte in the reservoir space.

9. A system for transportation of electrolyte according to claim 6 wherein the support structure is further comprised of either absorptive or non-absorptive material.

10. A nickel zinc electrochemical cell comprising:
a reservoir space located within the cell and below electrodes of the cell; and
at least one layer of absorptive material situated between the electrodes, these layers of absorptive material being longer in length so as to protrude into the reservoir space,
where the reservoir space further comprises a support structure.

11. The invention according to claim 10 wherein the at least one layer of absorptive material is situated between various electrodes of the cell.

12. The invention according to claim 10 wherein the at least one layer of absorptive material is situated between each electrode of the cell.

13. The invention according to claim 10 wherein the at least one layer of absorptive material defines a path along which electrolyte can travel from the reservoir space to the electrodes, and from the electrodes to the reservoir space.

14. The invention, according to claim 10, wherein the at least one layer of absorptive material, being longer in length, protrudes from the bottom of the electrode stack, the protruding length being folded in an “accordion” fashion, rolled up, or having any other geometric configuration so as to increase the surface area of absorptive material protruding into the reservoir space.

15. The invention according to claim 10 wherein the support structure is rolled up, folded, or otherwise geometrically configured so as to sustain the at least one layer of absorptive material.

16. The invention according to claim 10 wherein the support structure has the effect of providing additional free volume of electrolyte in the reservoir space.

17. A method of manufacturing an electrochemical cell comprising the steps of:
providing a cathodic electrode;
providing an electrolyte;
providing an anodic electrode;
associating with the electrodes a:
reservoir space located within the cell and below the electrodes; and
at least one layer of absorptive material situated between the electrodes, the at least one layer of absorptive material being longer in length so as to protrude into the reservoir space; and
providing a casing with which to house the electrodes, electrolyte, absorptive material and reservoir space.

18. A method of manufacturing an electrochemical cell according to claim 17 wherein the reservoir space further comprises a support structure.
